(19) United States
(12) Patent Application Publication
(10) Pub. No.: US 2011/0099372 A1
(43) Pub. Date: Apr. 28, 2011

(54) METHOD AND SYSTEM FOR PROVIDING PEER-TO-PEER VIDEO ON DEMAND

(76) Inventors: Siddhartha Annapureddy, Palo Alto, CA (US); Rajen Jaswa, Saratoga, CA (US); Yuri Prostota, Palo Alto, CA (US); Yoshfumi Nishida, Palo Alto, CA (US); Meng Zhang, Mountain View, CA (US)

(21) Appl. No.: 12/604,400

(22) Filed: Oct. 23, 2009

(51) Int. Cl. G06F 15/16; H04L 9/32; H04N 7/173

(52) U.S. Cl. 713/168; 709/217; 709/204; 725/87

(57) ABSTRACT

A method in which user generated video content is distributed over a peer to peer network as video on demand. Video is rendered during download and a user may request a specific point in the video content and that point and all subsequent video content will be downloaded and rendered first via the peer to peer network.

### FIELD OF THE INVENTION

The present invention generally relates to the sharing and distribution of video content over an electronic information network. The present invention more specifically relates to a process in which users may access video data and/or audio data over a peer-to-peer communications network.

### BACKGROUND OF THE INVENTION

Presently, there is a substantial Internet culture of on-line sharing of video content. The method in which this is done is often through peer-to-peer (P2P) networks. P2P networks are computer networks that provide an alternative to central server distribution methods. P2P networks and may be operated at a reduced cost burden to a service provider to the extent that data storage is facilitated by network members rather than a central server operated by the service provider.

P2P file transfer often works by dividing a large video data program into a plurality or multiplicity of parts. For example, one file may have 100 parts. While trying to view that file, a user would connect to one or more peers, for example, 5 peers A, B, C, D, and E. Those peers begin sending the user seemingly random pieces that they possess, so A could potentially transfer piece 25, while B concurrently transfers piece 12, C transfers 98, D transfers 57, and E transfers 2. Once a piece finishes loading, that peer will begin to send the user another piece until all 100 pieces are there. Further, such content transfers are often managed by torrent files which assemble meta-information about the pieces; these files are often made available by various web entities such as mininova, pirate bay, or isohunt, then the download is managed by a 3^{rd} party client program such as Bittorrent or Utorrent.

A core issue with this process is that this process lacks an inclusive method with which to view the shared video content live during a download as streamed content, further the process lacks an option to choose which pieces of a file are downloaded.

Traditional video on demand (hereinafter, “VOD”) systems, like Youtube, are client-server systems, which use the VOD service providers' CPU, storage, uplink bandwidth, and require the broadcaster to upload content and provide the license guarantee to the service provider. This has the following consequences: the VOD service provider has the open-ended cost of CPU, storage and uplink bandwidth, and the VOD provider is liable to license infringement lawsuits, since they cannot get the broadcaster to validate each VOD broadcast.

### SUMMARY OF THE INVENTION

A first example of the presently invented method involves a first seeder, which makes aware to a tracking entity, possession of video content to be shared, which other users may request and view. The seeder can upload video content to a number of peers. These peers may in turn upload the video content to other. The tracking entity could keep the information about which pieces of the video content are held by which of the peers. The presently invented method involves an encrypted transmission of the video content from a seeder to a second user; as it is received, the video content is unencrypted and rendered for the second user. The second user may at any point choose which portion of the video content is being downloaded and rendered throughout the course of the download. Throughout the course of the download, if a third or any subsequent users connect to the tracking entity and request the video content, they will begin downloading from the first seeder and then additionally from the second user. During their own download, the second user will not have the video content in its entirety but may still upload the portions it does have to third and subsequent users.

Once the second user has in its entirety the downloaded video content, he becomes known as a second seeder and may continue to upload the video content to additional users. All seeders and users may specify to the tracking entity how much of their own bandwidth they will allow for the transfer of video content. This method is most effective at sharing video content when many seeders and users are uploading content since any single downloading user may take advantage of shared bandwidth of multiple users improving the rate of downloading. As it is common for most internet service providers (hereafter: ISP) to allow their customers significantly higher downloading bandwidth than uploading it follows that even if seeders and users authorize full use of their uploading bandwidth, subsequent downloading users would be able to make use of many times the number of uploading seeders/users before their maximum downloading rate would be reached.

The tracking entity would maintain statistics on the uploading and downloading history of all users. Various benefits could be given to those users who had a community beneficial ratio of uploaded data to downloaded data. This method of VOD could be used in either a live meeting situation or as a delayed broadcast.

In certain aspects of the invented method the initial seeder of the content is also the tracking entity.

### INCORPORATION BY REFERENCE

All publications mentioned herein are incorporated herein by reference to disclose and describe the methods and/or materials in connection with which the publications are cited. All publications, patents, and patent applications mentioned in this specification are herein incorporated by reference in their entirety and for all purposes to the same extent as if each individual publication, patent, or patent application was specifically and individually indicated to be incorporated by reference.

Such incorporations include U.S. Pat. No. 6,711,622 (Inventors: Michael J. Fuller et al; Issued on Mar. 23, 2004) titled, “Video and audio streaming for multiple users”; U.S. Pat. No. 7,047,406 (Inventors: Jörg Gregor Schleicher et al; issued on May 16, 2006) titled, “Method and system for providing a secure peer-to-peer file delivery network”; U.S. Pat. No. 6,892,210 (Inventors: Jason Erickson et al; Issued on May 10, 2005) titled “Database management and synchronization across a peer-to-peer network”; U.S. patent application Ser. No. 11/384,238 (Inventor: Craig Howard Seidel; Filed on Mar. 17, 2006) titled “Peer-to-peer gateway”; U.S. patent application Ser. No. 11/519,990 (Inventors: Andrew Hickmott et al; Filed on Sep. 12, 2006) titled “Security techniques for cooperative file distribution”; U.S. patent application Ser. No. 12/112,980, titled “Formatting Information for Transmission over a Communication Network”; U.S. patent application Ser. No. 12/112,759, titled “Sharing of Information over a Communication Network”; and PCT Application No. PCT/US2008/061921 (Inventors: Anne Aaron et al; Filed Apr. 29, 2008) titled “Sharing of Information and Formatting Information for Transmission over a Communication Network”.

The publications discussed or mentioned herein are provided solely for their disclosure prior to the filing date of the present application. Nothing herein is to be construed as an admission that the present invention is not entitled to antedate such publication by virtue of prior invention. Furthermore, the dates of publication provided herein may differ from the actual publication dates which may need to be independently confirmed.

### BRIEF DESCRIPTION OF THE DRAWINGS

These, and further features of the invention, may be better understood with reference to the accompanying specification and drawings depicting the example, in which:

FIG. 1 is a block diagram of a peer-to-peer (P2P) network;

FIG. 2 is a block diagram of the data composition of video content;

FIG. 3 is a block diagram of an exemplary peer system;

FIG. 4 is a block diagram of an exemplary video server;

FIG. 5 is a block diagram of an exemplary user interface for video on demand;

FIG. 6 is a flow chart of data flow in an exemplary method of sharing video content;

FIG. 7 is a flow chart of an exemplary method of authenticating; and

FIG. 8 is a block diagram of a second exemplary P2P network.

### DETAILED DESCRIPTION

In describing aspects of the invention, certain terminology will be utilized for the sake of clarity. Such terminology is intended to encompass the recited example, as well as all technical equivalents, which operate in a similar manner for a similar purpose to achieve a similar result.

It is to be understood that this invention is not limited to particular aspects of the present invention described, as such may, of course, vary. It is also to be understood that the terminology used herein is for the purpose of describing particular aspects only, and is not intended to be limiting, since the scope of the present invention will be limited only by the appended claims.

Methods recited herein may be carried out in any order of the recited events which is logically possible, as well as the recited order of events.

Where a range of values is provided herein, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the methods and materials are now described.

It must be noted that as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

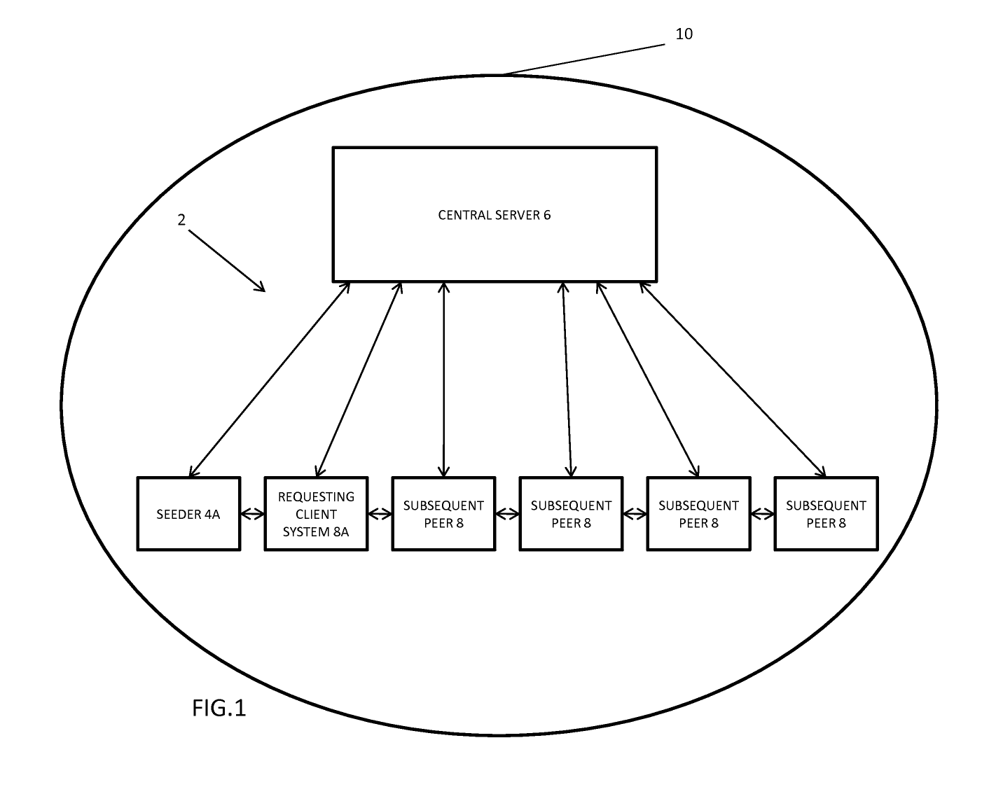

Referring now to FIG. 1, FIG. 1 is a block diagram of a first peer-to-peer (P2P) network 2. The P2P network 2 includes two or more peer systems 4, 8. An originating client system 4A, informally known and hereafter referred to as a seeder 4A, is the source of multimedia files to be shared across the network 2. For the purposes of this disclosure, the initial seeder 4A will be labeled with the element number 4A and a seeder 4 in a general case, or a non specific seeder 4, which is created by the maturing of the P2P network 2, will be labeled with the element number 4. In a first example of a P2P network 2, the seeder 4A connects with both a central server 6 which can be used as a tracking entity and at least one requesting client system 8 informally known and hereafter referred to as a leecher 8. For purposes of this disclosure, when a specific requesting client system 8A is referred to it will be labeled with the element number 8A, and when being referred to in general, or when subsequent requesting client systems (leechers) 8 beyond a specific case is referred to, they will be labeled with the element number 8. Each seeder 4 can be connected to any number of the leechers 8 from none to as many as all of the leechers 8. This is optionally decided by the seeder 4. Additionally each of the leechers 8 may be connected to any number of other leechers 8. Each of the leechers 8 is also connected to the central server 6. The seeder 4A shares the video content to all directly connected leechers 8; the leechers 8 in turn share the segments of the video content that they currently posses with all other leechers 8 that they are directly connected to. Once video content has been shared in its entirety to a leecher 8, that leecher 8, possessing all segments of the video content, performs the same tasks as a seeder 4. The central server 6 can optionally act as a peer that connects to all members of the P2P network 2, beginning first as a leecher 8 and then becoming a seeder 4 as soon as the central server 6 has all segments of the video content. Additionally the central server 6 can serve as a tracking entity which facilitates the connections between the peers (seeders 4 and leechers 8) through a mass network 10 such as the internet, as well as keeping lists of all peers and their download and uploads statistics. The peers 4, 8 and the central server 6 do not physically reside in the mass network 10—FIG. 1 only serves to show communication pathways and provides no suggestion of physical location.

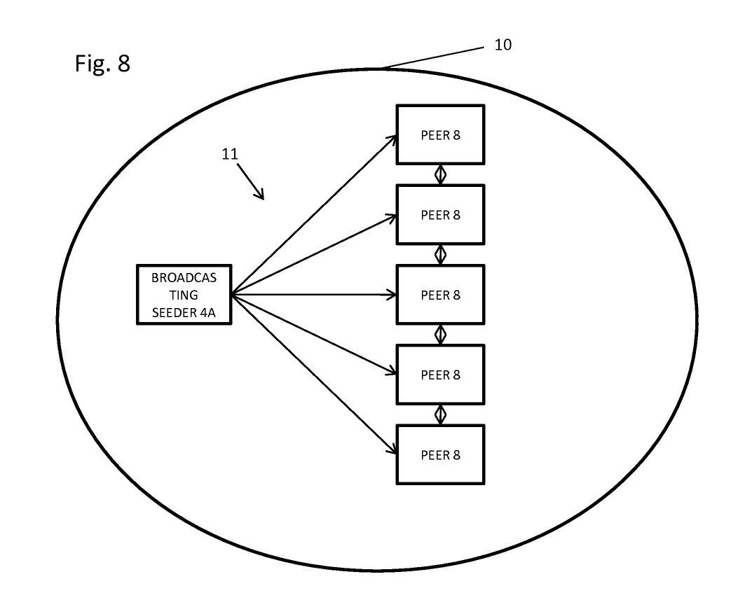

Referring to FIG. 8, FIG. 8 is a block diagram of a second exemplary P2P network 11. In a second exemplary P2P network 11, the role of tracking entity is performed by the initial seeder 4A and the central server 6 of FIG. 1 which composes the initial seeder 4A. The connection between members of the network can be facilitated by a client software or any other suitable method known in the art. Alternatively to the initial seeder 4A performing the role of a tracker, a distributed hash table (DHT) technique could be used to distributedly maintain all index entries of peers for each video data blocks. Using this network 11, the legal responsibility for the video content rests with the initial seeder 4A.

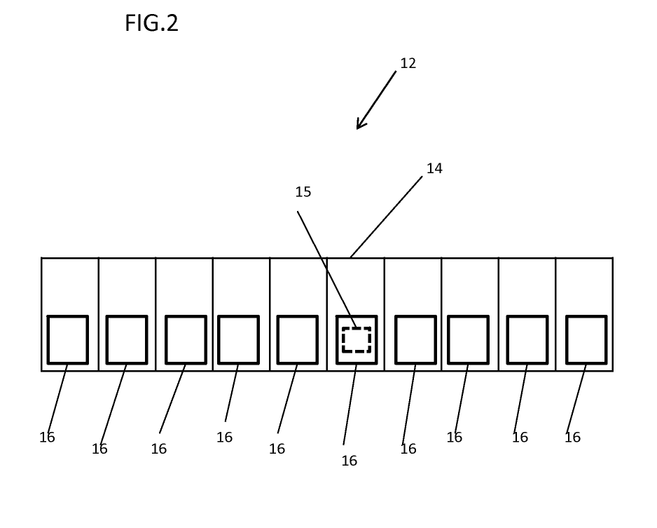

Referring to FIG. 2, FIG. 2 is a block diagram of the data composition of video content 12. Video content 12 when arranged as data consists of multiple segments 14. Each of these segments 14 comprises a given length of video, for example 30 seconds. Each segment 14 contains data packets 16 which may be interpreted by a computer as video. The number of packets per second of video can vary greatly depending on temporal resolution of video content 12, however assume for the sole purpose of subsequent examples that there are about seventy-five packets 16 per second of video data 12. Another way to view a breakdown of the video data 12 is as a data block 15. A data block 15 could be as small as a one of the packets 16 and as large as a segment 14. The denomination of a data block 15 would be used by a tracker in denoting which members of the P2P network 2 had what portions of the video data 12.

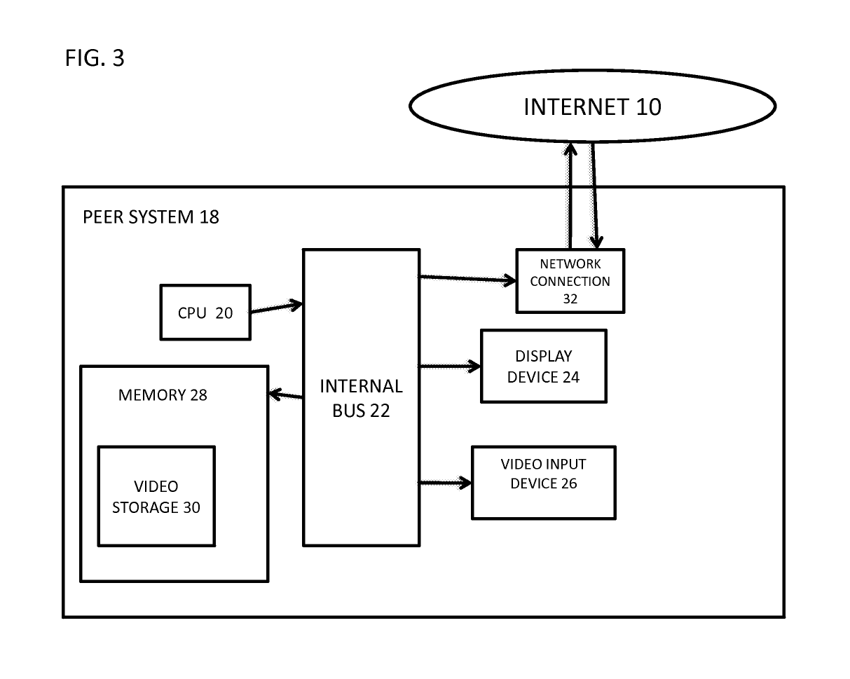

Referring to FIG. 3, FIG. 3 is a block diagram of an exemplary peer system 18. A peer system 18 would include a CPU 20, connected to an internal BUS 22, which would have some form of display device 24, a video input device 26, a memory 28 in which a video archive 30 could be saved, and some form of network adapter 32 for connecting to a mass network 10 such as the internet. A seeder 4 or a leecher 8 would include any or all of these components. An example of an acceptable peer system 18 would be the Alienware M17x laptop as marketed by the Dell corporation; a Macbook pro as marketed by Apple Computer Inc.; an internet enabled desktop computer; a system enabled to have the possibility of running the computer game, “World of Warcraft” as produced and marketed by Blizzard Entertainment; a network enabled mobile device such as an Apple iPhone; and any other suitable device known in the art.

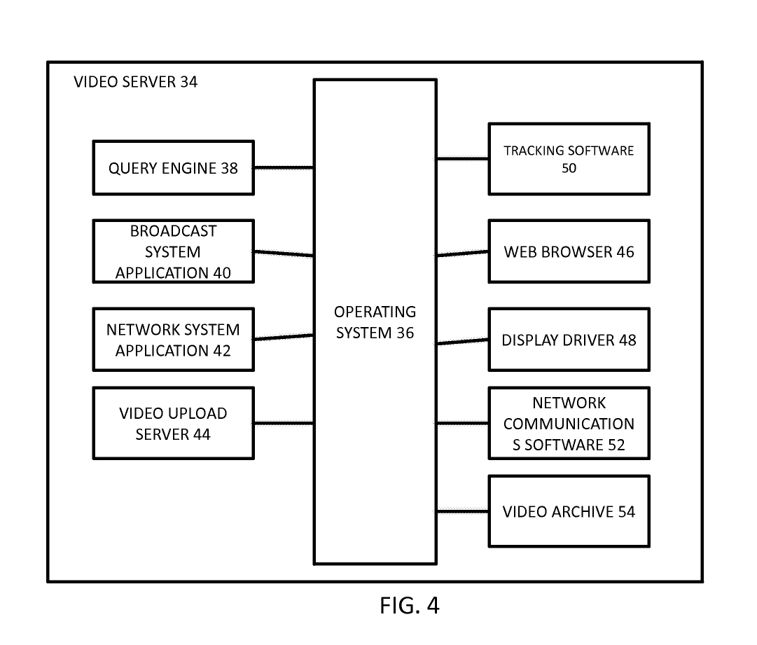

Referring to FIG. 4, FIG. 4 is a block diagram of an exemplary video server 34. A video server's 34 software components would consist of an operating system 36, which would allow the operation of: a query engine 38 for facilitating the operation of the video server 34, a broadcast system application 40 to facilitate connections with peer systems 18, a network system application 42 to support a network, a video upload server 44 in order to receive video content 12, a web browser 46, display drivers 48, tracking software 50, and network communications software 52. In certain variations on the invented method video archive software 54 would also be included in order to store uploaded video content 12 from a seeder 4A in order to assist in video sharing.

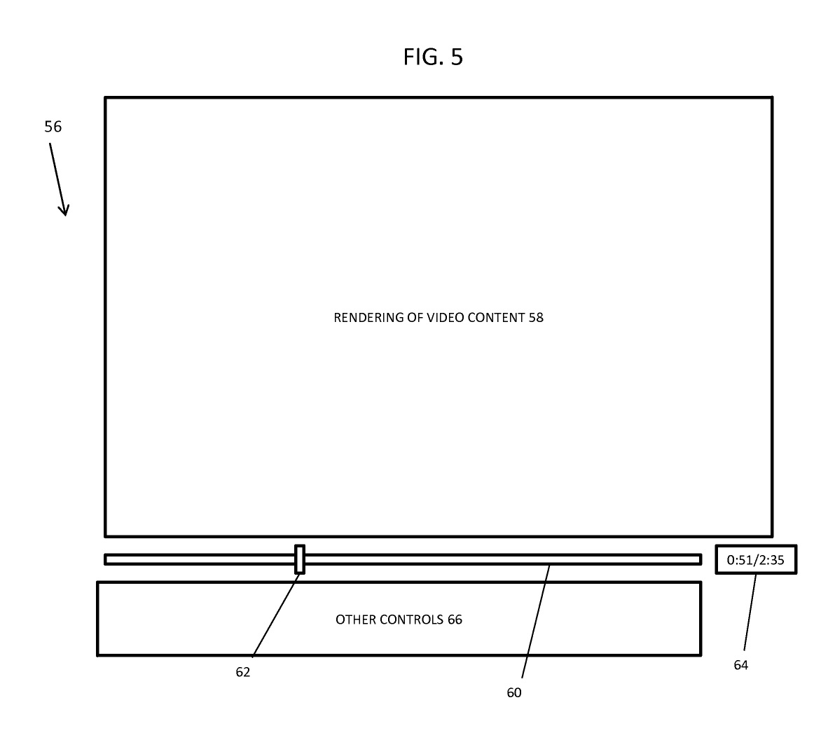

Referring now generally to FIGS. 1-4 and more specifically to FIG. 5, FIG. 5 is a block diagram of an exemplary user interface 56 for video on demand. In a first exemplary method of present invention a seeder 4A will make known to the central server 6 ownership of video data 12. The central server 6 will then allow this video to be searchable in a standard query web engine 38. Alternatively, in a second exemplary method of present invention a client software could be used to search through archives of video content made available by a plurality of seeders 4. A requesting client system 8A can then search for a video data 12 that a seeder 4A has made available, and once the video data 12 is selected, the requesting client system 8A is transferred to a user interface 56 as shown in FIG. 5. Optionally the originating client system 4A may also be viewing this user interface 56, and have the video data 12 rendered concurrently with other peers 8. The requesting client system 8A, or “leecher”, begins receiving the shared video data 12, starting from the first data block 15 and proceeding chronologically from all seeders connected, and any other connected leechers 8 as long as they possess relevant data blocks 15 of the video data 12. The user interface 56 renders the video data 12 in a screen 58, and the progress of the rendering is shown via a progress bar 60 and a progress cursor 62 that indicates to the requesting client system 8A how far through the video data 12 rendering currently is and how much still remains. This can optionally also be shown in a digital format 64. The progress cursor 62 may be altered by a user of the requesting client system 8A in order to adjust which data block 15 the requesting client system 8A wishes to have rendered. For example, if the progress cursor 62 were to be dragged from the beginning of the progress bar to a third of the way through, a data block 15 from roughly a third of the way into the video data 12 followed by subsequent data blocks 15 would be requested and rather than receiving from the connected peers 4, eight data blocks 15 from the beginning of the video data 12. Optionally other controls 66 could be incorporated into the user interface 56; these could include but are not limited to volume controls, quality controls, full screen controls, or add to a favorite list control.

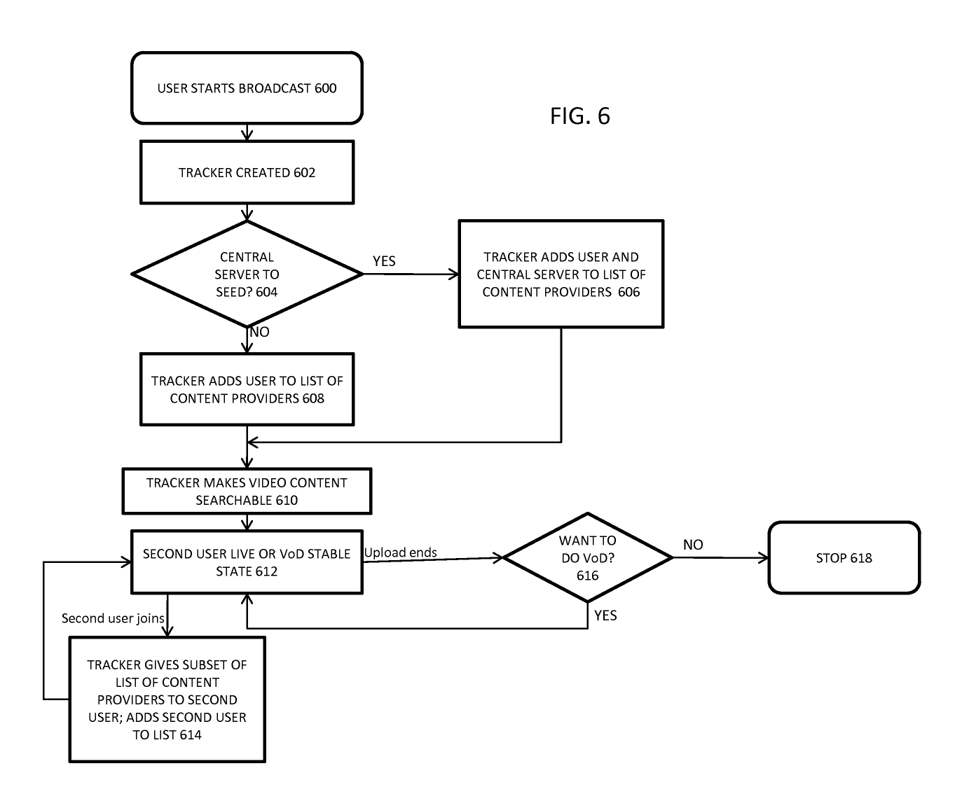

Referring now to FIG. 6, FIG. 6 is a flow chart of data flow in an exemplary method of sharing video content. A first exemplary method of the present invention begins with an originating client system 4 broadcasting its possession of video data 12, the central server 6 receives the title or the title is broadcast by the initial seeder 4 depending on which aspect of the method is used (600). The originating client system 4A can at this point decide how much bandwidth to allow for uploading the video data 12. Optional incentives can be given for allowing larger amounts of personal bandwidth to be used to facilitate sharing of video data 12. In the following step, the central server 6 creates a tracker for the video content or the initial seeder 4A is established as the tracker (602). Alternatively to use of a tracker, a distributed hash table (DHT) technique could be used to distributedly maintain all index entries of peers for each video data blocks 15. Erasure code can optionally be used to improve the persistence of video data blocks 15 in the peer-to-peer network 2 or network 11. Since there are a number of different video formats on the internet, including flv, .avi, .rm, .wmv, an easy way to support all of them on the central server 6 or client software can optionally use hook technology to hook write and read operations in any third party digital media player and feed the player with the video data 12 which is fetched from other peers 4, 8 or server 6. As previously noted the central server 6 may optionally assist in the seeding and distribution, in step 604 the central server 6 can either, in addition to its required role, also serve as a seeder 4 or remain solely as a tracking entity. If the central server 6 does seed the video data 12, central server 6 adds itself to the tracker's list of content providers (606) then proceeds to step 610; if the central server 6 is to remain only as a tracking entity only the initial seeder 4A is added to the tracker list of content providers (608). The central server 6 allows the video data 12 to be searchable in either a web query engine or through client software in order for requesting client systems 8 to request specific video data 12 (610). Optionally specific originating client systems 4A may create their own channels to facilitate search requests for their video content 12, on these channels the originating client systems 4A could have a plurality of video contents 12 available.

The next phase of this exemplary method of present invention may proceed differently depending on how mature the process is; two possible paths may then be taken (612). To begin this phase of the method, when a first requesting client system 8A joins the session, the tracker connects the requesting client system 8A to either the entirety or a subset of the current list of content providers, adding that user 8A to the list in the process (614). The download and rendering/upload process then proceeds as described in a previous paragraph discussing FIG. 5. Optionally the downloading and rendering/uploading process may include an encryption of the data blocks 15 as they are uploaded and a decryption processes as they are received and rendered. The optional encryption process may be facilitated by the central server 6 or a client software which would control any encryption keys involved. Step 612 and 614 loop indefinitely as long as additional requesting client systems 8 continue to join the session. Once all leechers 8 have obtained all data blocks 15 of the video data 12 and have become seeders 4, uploading ends since there are no more requests for the video data 12, which sends the process to step 616, where the video data 12 remains available as a video on demand. The networks 2, 11 used in the initial live broadcast and in making video content 12 available on demand could be different. Additionally the networks 2, 11 used for the video on demand functionality could use video data with a lower number of packets per second than that of the data 12 used in the initial live broadcast. Though these networks 2, 11 could be different, members of these networks 2, 11 could be the same and the nodes involved in transferring media files on both a live broadcast network and a video on demand network could be overplayed and be one in the same. The process remains in this loop until either all seeders 4 leave the session or the tracker disconnects with a lack of a DHT. As long as the video is available the process may keep looping back to step 612. Once there are no seeders 4 remaining in the session the video data is no longer available, or if there is no tracker to direct downloads the process ends 618. However, if the option to use the central server 6 as a seeder 4 and as the tracker was taken, it is likely that the video sharing session will not have a foreseeable end.

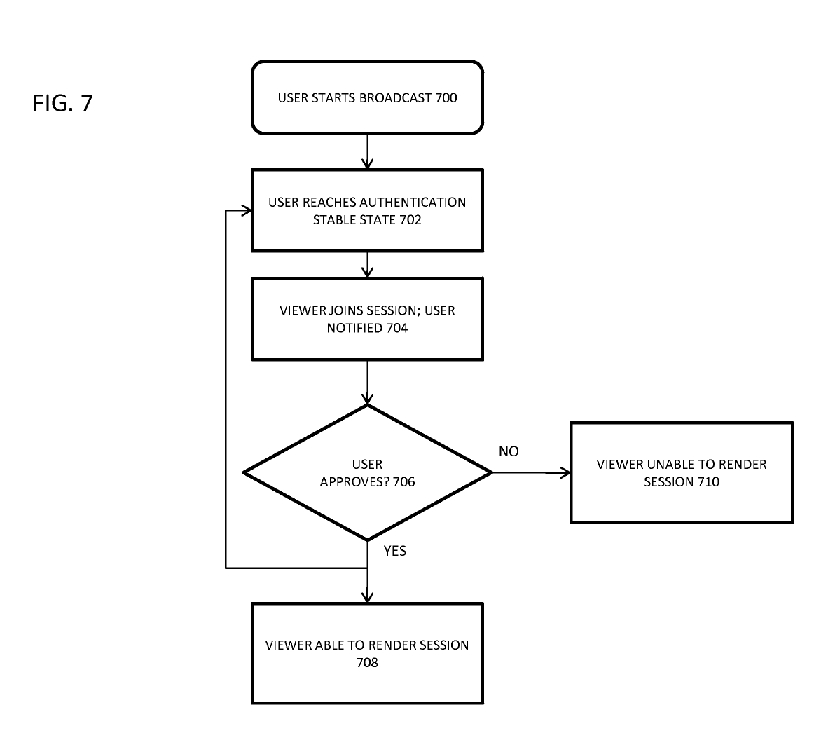

Referring now to FIG. 7, FIG. 7 is a flow chart of an exemplary method of authenticating. Optionally the invented method displayed in FIG. 6 may include additional steps. As before, an originating client system 4 begins broadcast of video data 12 (700). The originating client system 4 stays idle until the requesting client systems 8 attempt to join the video session (702). The requesting client system 8A transmits an authentication key to the originating client system 4 with a request to join a video session supported by the originating client system 4A, whereupon the originating client system is provided with the authentication key and is notified of the request by the requesting client system 8A to join the video session (704). The seeder 4A attempts to validate the authentication key as transmitted by the requesting system 8A in step 706 and determines whether to allow this particular requesting client system 8A into the video session. If authenticated and allowed by the seeder 4A, the requesting client system 8A begins to download and render the video data 12 in step 708. The originating client system 4A returns to step 702 to upload video data and wait for additional requesting systems 8. If the originating client system 4A does not allow that particular requestor 8A to join the session, the particular requestor 8A will not be able to download and render the video data 12 (710). Various common methods could be used in order to achieve a proper authentication key like client assigned temporary or permanent passwords, PKI certificates, digital signatures, secure shell (SSH), a list of allowed IP addresses, creation of user accounts followed by account information checks, or any other suitable means known in the art.

For the purposes of this disclosure and claimed matter the term “network directory” is to be defined as a list of all members of a network maintained by either a tracker or a distributed hash table.

The foregoing disclosures and statements are illustrative only of the Present Invention, and are not intended to limit or define the scope of the Present Invention. The above description is intended to be illustrative, and not restrictive. Although the examples given include many specificities, they are intended as illustrative of only certain possible examples of the Present Invention. The examples given should only be interpreted as illustrations of some of the examples of the Present Invention, and the full scope of the Present Invention should be determined by the appended claims and their legal equivalents. Those skilled in the art will appreciate that various adaptations and modifications of the just-described examples can be configured without departing from the scope and spirit of the Present Invention. Therefore, it is to be understood that the Present Invention may be practiced other than as specifically described herein. The scope of the present invention as disclosed and claimed should, therefore, be determined with reference to the knowledge of one skilled in the art and in light of the disclosures presented above.

What is claimed:

1. A method for providing a multimedia content file to a requesting client system over the internet using a peer-to-peer (“P2P”) network, the method comprising:
a. a central server receiving a title of the multimedia content file from an originating client system;
b. allowing the originating client system to respond to requests for the video data file received from the peer network;
c. adding the title to a title listing accessible to the requesting client system;
d. receiving a request from the requesting client system to access the video content file; and
e. communicating the request to the originating client system, whereby the originating client system is enabled to fulfill the request via the peer network.

2. The method of claim 1, further comprising:
a. directing the originator to store the video content file on at least one additional client system of a network; and
b. enabling the requesting client system to access the multimedia content file from the at least one additional client system.

3. The method of claim 1, wherein the originating client system stores a plurality of multimedia content files, and transmits each of the plurality of multimedia content files over the network.

4. The method of claim 1, further comprising:
a. transmitting the video content file from the originating client system to a plurality of additional client systems of the network; and
b. enabling the plurality of additional client systems to transmit the video content file to the requesting client system.

5. The method of claim 4, further comprising informing the central server of each network address of each additional client system storing the video content file, whereby the central server directs requests for access to the video content file received from the P2P network to one or more of the combination of the originating client system and the plurality of additional client systems.

6. The method of claim 1, further comprising:
a. encrypting the video content file;
b. providing an encryption key to the requesting client system;
c. transmitting the encrypted video content file to the requesting client system; and
d. decrypting the encrypted video content file by the requesting client system.

7. The method of claim 6, further comprising:
a. transmitting the encrypted multimedia content file from the originating client system to a plurality of additional client systems of the network; and
b. enabling the plurality of additional client systems to transmit the encrypted multimedia content file to the requesting client system.

8. The method of claim 1, further comprising:
a. transmitting the multimedia content file to the central server;
b. encrypting the multimedia content file as directed by the central server; and
c. transmitting the encrypted multimedia content file to the originating client system.

9. The method of claim 9, further comprising:
a. providing an encryption key to the requesting client system;
b. transmitting the encrypted multimedia content file to the requesting client system; and
c. decrypting the encrypted multimedia content file by the requesting client system.

10. The method of claim 9, further comprising:
a. transmitting the encrypted multimedia content file from the originating client system to a plurality of additional client systems of the P2P network; and
b. enabling the plurality of additional client systems to transmit the encrypted multimedia content file to the requesting client system.

11. The method of claim 11, further comprising informing the central server of each network address of each additional client system storing the encrypted multimedia content file, whereby the central server directs requests for access to the encrypted multimedia content file received from the P2P network to one or more of the combination of the originating client system and the plurality of additional client systems.

12. A method of providing a video on demand service as well as a live broadcast service both using peer to peer technology, the method comprising:
a. registering an originating client system in a network directory;
b. accepting a first media title from the originating client system;
c. publishing the media title to the network;
d. the originating client system broadcasting the media file over the network in real time, wherein the originating client system acts as a tracker for broadcast to requesting systems; and
e. Providing the means for transmitting the media file from the originating client system, subsequent to the real time broadcast across a peer network to requesting clients wherein the originating client system acts as the tracker for the transmission.

13. The method of claim 12, further comprising:
a. Encrypting the first media file; and
b. Transmitting the first media file as encrypted from the first client system to the second client system.

14. The method of claim 13, further comprising providing a decryption key to the second client system, whereby the second client system decrypts the transmitted encrypted first media file.

15. The method of claim 12, further comprising storing the media file on a plurality of additional client systems of the peer network; and selectively providing access to the plurality of additional client systems by the second client system to enable enhanced video on demand service.

16. The method of claim 12, wherein a requesting system may either chose to join into a live, real time broadcast service of the media file or become part of a video on demand service.

17. The method of claim 12, wherein the data units that compose the media file are a different temporal resolution between the live broadcast service to the video on demand service.

18. The method of claim 12, wherein a client in the peer network may serve as a node for both the live broadcast service and the video on demand service.

19. The method of claim 15, wherein the first client system directs requests for access to the first media file to one of the plurality of additional client systems of the peer network.

20. The method of claim 19, wherein the first client system allocates a transmission bandwidth for servicing access requests to the first media file, and the first client system directs requests for access to the first media file to one of the plurality of additional client systems of the P2P network to avoid exceeding the bandwidth allocation.

21. A system for providing a peer to peer (“P2P”) video on demand service, the system comprising:
a. a central server for registering a first client system in a P2P network directory of a P2P network, accepting a first media title from the first client system, and publishing the media title to the P2P network;
b. the first client system for providing the first media title to the central server, associating the first media title with a first media file, and transmitting the first media file to a plurality of additional client systems of the P2P network;
c. the plurality of additional client systems for providing video on demand access to the first media file; and
d. a requesting client system for requesting access to the P2P network directory, selecting the first media title, and receiving the first media file from the combination of the first client system and the plurality of additional client systems.

22. A method for providing a multimedia content file to a requesting client system within a peer-to-peer (“P2P”) network, the method comprising:
a. a central server receiving a title of the multimedia content file from an originating client system;
b. organizing the multimedia content file into a plurality of N successive data blocks;
c. storing each data block within a plurality of peer systems of the P2P network;
d. authorizing the plurality of peer systems of the P2P network to respond to requests for the video data file received from the P2P network;
e. adding the title to a title listing accessible to the requesting client system;
f. receiving a request from the requesting client system to access the multimedia content file;
g. communicating the request to the P2P network, whereby the P2P network is enabled to fulfill the request by an authenticating peer system; and
h. enabling the requesting client system to request a data block from the P2P system, whereby the requesting client system receives and renders the requested data block and each data block ordered in succession from the requested data block.

23. The method of claim 22, further comprising the requesting client system providing an authenticating key to the P2P network, wherein the P2P network transmits the requested data block to the requesting client system upon validation of the authentication data.
